(19) United States
(12) Patent Application Publication
(10) Pub. No.: US 2026/0342565 A1
(43) Pub. Date: Oct. 29, 2026

(54) CRYPTOGRAPHY SYSTEMS AND METHODS UTILIZING "LOW CONJECTURE" FOR PRIME IDENTIFICATION

(71) Applicant: NEUROVIGIL, INC., Moffett Field, CA (US)

(72) Inventor: Philip Low, Moffett Field, CA (US)

(73) Assignee: NEUROVIGIL, INC., Moffett Field, CA (US)

(21) Appl. No.: 19/710,113

(22) Filed: Jun. 16, 2026

Related U.S. Application Data
(63) Continuation of application No. PCT/US2024/062147, filed on Dec. 27, 2024.
(60) Provisional application No. 63/615,380, filed on Dec. 28, 2023.

(51) Int. Cl. H04L 9/30; H04L 9/08

(52) U.S. Cl. CPC H04L 9/3033; H04L 9/0877; H04L 9/302

(57) ABSTRACT

Cryptography systems and methods utilizing the “Low conjecture” for prime are identification are disclosed herein. One aspect relates to a cryptography method. The cryptography method includes receiving a request for encryption of a digital message, identifying at least one prime number via application of the “Low conjecture”, generating an encryption key based on the at least one prime number, distributing the key to at least a destination device, encrypting the digital message with the encryption key, and sending the encrypted digital message from a source device to a destination device.

### CROSS-REFERENCE TO RELATED APPLICATIONS

This application is a continuation of International Patent Application No. PCT/US2024/062147, filed on Dec. 27, 2024, which claims the benefit of U.S. Provisional Application No. 63/615,380, filed on Dec. 28, 2023, and entitled “CRYPTOGRAPHY SYSTEMS AND METHODS UTILIZING "LOW CONJECTURE" FOR PRIME IDENTIFICATION”. The entire disclosures of the aforementioned applications are incorporated by reference herein in their entireties for all purposes.

### BACKGROUND

As computer communication has become more prevalent, the importance of secure encryption of these communications has increased. While encryption is of crucial importance in secure computer communication, the advancement of technology has only increased the challenges of encryption as faster processing allows improved breaking of encryption. Further, the advance of technology has led to a world where massive amounts of critical and sensitive information are accessible via a network or communicated across a network. Thus, improved encryption is desirable.

### BRIEF SUMMARY

Aspects of the present relate to cryptography systems and methods utilizing the “Low conjecture” for prime are identification are disclosed herein. One aspect relates to a cryptography method. The cryptography method includes receiving a request for encryption of a digital message from a source device, identifying at least one prime number via application of a “Low conjecture”, generating an encryption key based on the at least one prime number, distributing the key to at least a destination device, encrypting the digital message with the encryption key, and sending the encrypted digital message from the source device to the destination device.

In some embodiments, identifying the at least one prime number via application of the “Low conjecture” includes identifying a base prime number (“P”), identifying at least one prime candidate from the base prime number, and confirming the at least the prime candidate as a prime number. In some embodiments, identifying the at least one prime candidate can include determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P}, wherein Φ_{P} = N-k•P. In some embodiments, k is a positive integer value. In some embodiments, the at least one prime candidate can include the upper prime candidate.

In some embodiments, the request for encryption of the digital message is received at a source device. In some embodiments, the source device can include a cryptography module configured to encrypt the digital message. In some embodiments, the cryptography module can include a Hardware Security Module (HSM).

In some embodiments, the encryption key is generated according to an Rivest-Shamir-Adleman (“RSA”) algorithm. In some embodiments, generating the encryption key can include generating a public key exponent, and generating a private key exponent based on the public key exponent and at least one totient of the at least one prime number identified via application of the “Low conjecture”. In some embodiments, generating the encryption key can include selecting a first prime number “p” and a second prime number “q”, and forming a modulus “n” by multiplying “p” and “q”. In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) can include multiplying (p-1) with (q-1).

In some embodiments, generating the encryption key can include generating a public key and a private key. In some embodiments, the public key can include a public exponent “e” and the modulus “n”. In some embodiments, the private key is derived based on the modulus “n”, the public exponent “e”, and the Euler’s totient function “φ(n)”).

In some embodiments, generating the encryption function further comprises calculating Carmichael’s totient (“λ(n)”). In some embodiments, Carmichael’s totient λ(n) is equal to the least common multiple of p-1 and q-1.

One aspect relates to a system. The system can include a source device including one or more processors and a memory including instructions that when executed cause the one or more processors to receive a request for encryption of a digital message, identify at least one prime number via application of the “Low conjecture”, generate an encryption key based on the at least one prime number, distribute the key to at least a destination device, encrypt the digital message with the encryption key, and send the encrypted digital message to the destination device.

In some embodiments, identifying the at least one prime number via application of the “Low conjecture” can include identifying a base prime number (“P”), identifying at least one prime candidate from the base prime number, and confirming the at least the prime candidate as a prime number. In some embodiments, identifying the at least one prime candidate can include determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P.} In some embodiments, Φ_{P} = N-k•P. In some embodiments, k is a positive integer value.

In some embodiments, the at least one prime candidate can include the upper prime candidate. In some embodiments, the request for encryption of the digital message is received at a source device. In some embodiments, the source device can include a cryptography module configured to encrypt the digital message. In some embodiments, the cryptography module can include a Hardware Security Module (HSM).

In some embodiments, the encryption key is generated according to an Rivest-Shamir-Adleman (“RSA”) algorithm. In some embodiments, generating the encryption key can include generating a public key exponent, and generating a private key exponent based on the public key exponent and at least one totient of the at least one prime number identified via application of the “Low conjecture”. In some embodiments, generating the encryption key includes selecting a first prime number “p” and a second prime number “q”, and forming a modulus “n” by multiplying “p” and “q”. In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) can include multiplying (p-1) with (q-1). In some embodiments, generating the encryption key can include generating a public key and a private key. In some embodiments, the public key can include a public exponent “e” and the modulus “n”. In some embodiments, the private key is derived based on the modulus “n”, the public exponent “e”, and the Euler’s totient function “φ(n)”).

In some embodiments, generating the encryption function further includes calculating Carmichael’s totient (“λ(n)”). In some embodiments, Carmichael’s totient λ(n) is equal to the least common multiple of p-1 and q-1.

One aspect relates to signature authentication method. The method includes receiving at at least one processor a request for generation of a signature for a transaction, identifying, for example at the at least one processor, at least one prime number via application of the “Low conjecture”, generating, for example at the at least one processor, a private key based on the at least one prime number, and generating, for example at the at least one processor, a digital signature based on the private key.

In some embodiments, identifying the at least one prime number via application of the “Low conjecture” includes identifying a base prime number (“P”), identifying at least one prime candidate from the base prime number, and confirm the at least the prime candidate as a prime number. In some embodiments, identifying the at least one prime candidate includes determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P.} In some embodiments, Φ_{P} = N-k•P. In some embodiments, k is a positive integer value. In some embodiments, the at least one prime candidate can include the upper prime candidate.

In some embodiments, the request for generation of the signature is received at a source device. In some embodiments, the source device includes a cryptography module configured to generate the private key. In some embodiments, the cryptography module includes a Hardware Security Module (HSM).

In some embodiments, the encryption key is generated according to an RSA algorithm. In some embodiments, generating the encryption key includes generating a public key exponent, and generating a private key exponent based on the public key exponent and at least one totient of the at least one prime number identified via application of the “Low conjecture”. In some embodiments, generating the encryption key includes selecting a first prime number “p” and a second prime number “q”, and forming a modulus “n” by multiplying “p” and “q”. In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) includes multiplying (p-1) with (q-1). In some embodiments, generating the encryption key includes generating a public key and a private key. In some embodiments, the public key includes a public exponent “e” and the modulus “n”. In some embodiments, the private key is derived based on the modulus “n”, the public exponent “e”, and the Euler’s totient function “φ(n)”).

In some embodiments, generating the encryption function further includes calculating Carmichael’s totient (“λ(n)”). In some embodiments, Carmichael’s totient λ(n) is equal to the least common multiple of p-1 and q-1.

In some embodiments, the method further includes verifying the signature. In some embodiments, the signature is verified with a network node. In some embodiments, subsequent to the verification of the signature, the transaction is considered valid and is added to the blockchain.

One aspect relates to a system for signature authentication. The system includes one or more processors and memory including instructions that when executed cause the one or more processors to receive a request for generation of a signature for a transaction, identify at least one prime number via application of the “Low conjecture”, generate a private key based on the at least one prime number, and generate a digital signature based on the private key.

In some embodiments, identifying the at least one prime number via application of the “Low conjecture” includes identifying a base prime number (“P”), identifying at least one prime candidate from the base prime number, and confirming the at least the prime candidate as a prime number. In some embodiments, identifying the at least one prime candidate includes determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P.} In some embodiments, Φ_{P} = N-k•P. In some embodiments, k is a positive integer value. In some embodiments, the at least one prime candidate can include the upper prime candidate.

In some embodiments, the request for generation of the signature is received at a source device. In some embodiments, the source device can include a cryptography module configured to generate the private key. In some embodiments, the cryptography module can include a Hardware Security Module (HSM).

In some embodiments, the encryption key is generated according to an RSA algorithm. In some embodiments, generating the encryption key includes generating a public key exponent, and generating a private key exponent based on the public key exponent and at least one totient of the at least one prime number identified via application of the “Low conjecture”. In some embodiments, generating the encryption key includes selecting a first prime number “p” and a second prime number “q”, and forming a modulus “n” by multiplying “p” and “q”. In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) can include multiplying (p-1) with (q-1). In some embodiments, generating the encryption key includes generating a public key and a private key. In some embodiments, the public key includes a public exponent “e” and the modulus “n”.

In some embodiments, the private key is derived based on the modulus “n”, the public exponent “e”, and the Euler’s totient function “φ(n)”). In some embodiments, generating the encryption function further includes calculating Carmichael’s totient (“λ(n)”). In some embodiments, Carmichael’s totient λ(n) is equal to the least common multiple of p-1 and q-1.

One aspect of the present disclosure relates to a computer-program product tangibly embodied in a non-transitory machine-readable storage medium. The computer-program product including instructions that cause one or more data processors to perform a set of actions including: receive at at least one data processor a request for generation of a signature for a transaction, identify at least one prime number via application of a “Low conjecture”, generate a private key based on the at least one prime number, and generate a digital signature based on the private key.

In some embodiments, identifying the at least one prime number via application of the “Low conjecture” can include identifying a base prime number (“P”), identifying at least one prime candidate from the base prime number, and confirming the at least the prime candidate as a prime number. In some embodiments, identifying the at least one prime candidate can include determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P.} In some embodiments, Φ_{P} = N-k•P. In some embodiments, k is a positive integer value.

In some embodiments, the at least one prime candidate comprises the upper prime candidate. In some embodiments, the at least one processor can include a cryptography module that can generate the private key. In some embodiments, the cryptography module can include a Hardware Security Module (HSM). In some embodiments, the encryption key is generated according to an RSA algorithm.

In some embodiments, generating the encryption key can include generating a public key exponent, and generating a private key exponent based on the public key exponent and at least one totient of the at least one prime number identified via application of the “Low conjecture”. In some embodiments, generating the encryption key can include selecting a first prime number “p” and a second prime number “q”, and forming a modulus “n” by multiplying “p” and “q”.

In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) can include multiplying (p-1) with (q-1). In some embodiments, generating the encryption key can include generating a public key and a private key. In some embodiments, the public key can include a public exponent “e” and the modulus “n”. In some embodiments, the private key is derived based on the modulus “n”, the public exponent “e”, and the Euler’s totient function “φ(n)”).

In some embodiments, generating the encryption function further includes calculating Carmichael’s totient (“λ(n)”). In some embodiments, Carmichael’s totient λ(n) is equal to the least common multiple of p-1 and q-1. In some embodiments, the private key is derived based on the modulus “n”, the public exponent “e”, and Carmichael’s totient λ(n). In some embodiments, the instructions further cause one or more data processors to verify the signature. In some embodiments, the signature is verified with a network node. In some embodiments, subsequent to the verification of the signature, the transaction is considered valid and is added to the blockchain.

One aspect of the present disclosure relates to a computer-program product tangibly embodied in a non-transitory machine-readable storage medium. The computer-program product including instructions that cause one or more data processors to perform a set of actions including: receiving a request for encryption of a digital message at a source device, identifying at least one prime number via application of a “Low conjecture”, generating an encryption key based on the at least one prime number, distributing the key to at least a destination device, encrypting the digital message with the encryption key, and sending the encrypted digital message from the source device to the destination device.

In some embodiments, identifying the at least one prime number via application of the “Low conjecture” includes identifying a base prime number (“P”), identifying at least one prime candidate from the base prime number, and confirming the at least the prime candidate as a prime number.

In some embodiments, identifying the at least one prime candidate can include determining a sample value (“N”) where N = (P+1)²/2, identifying a lower number (“Φ”), and identifying an upper prime candidate (“λ”), wherein λ = (P+1)²-Φ. In some embodiments, Φ is the smallest prime number in a set Φ_{P.} In some embodiments, Φ_{P} = N-k•P. In some embodiments, k is a positive integer value.

In some embodiments, the at least one prime candidate can include the upper prime candidate. In some embodiments, the request for encryption of the digital message is received at a source device. In some embodiments, the source device can include a cryptography module configured to encrypt the digital message. In some embodiments, the cryptography module can include a Hardware Security Module (HSM).

In some embodiments, the encryption key is generated according to an Rivest-Shamir-Adleman (“RSA”) algorithm. In some embodiments, generating the encryption key can include generating a public key exponent, and generating a private key exponent based on the public key exponent and at least one totient of the at least one prime number identified via application of the “Low conjecture”.

In some embodiments, generating the encryption key can include selecting a first prime number “p” and a second prime number “q”, and forming a modulus “n” by multiplying “p” and “q”. In some embodiments, a size of the modulus corresponds to a strength of the encryption. In some embodiments, the modulus “n” has a length of at least 2048 bits.

In some embodiments, generating the encryption key further includes calculating Euler’s totient function (“φ(n)”) based on “p” and “q”. In some embodiments, calculating the Euler’s totient function (“φ(n)”) can include multiplying (p-1) with (q-1). In some embodiments, generating the encryption key can include generating a public key and a private key. In some embodiments, the public key can be a public exponent “e” and the modulus “n”. In some embodiments, the private key can be derived based on the modulus “n”, the public exponent “e”, and the Euler’s totient function “φ(n)”).

In some embodiments, generating the encryption function further includes calculating Carmichael’s totient (“λ(n)”). In some embodiments, the Carmichael’s totient λ(n) is equal to the least common multiple of p-1 and q-1.

### BRIEF DESCRIPTION OF THE DRAWINGS

The present disclosure is described in conjunction with the appended figures:

FIG. 1 is a schematic depiction of one embodiment of a cryptography system.

FIG. 2 is a flowchart illustrating one embodiment of a process for cryptography utilizing the “Low conjecture” for prime number identification.

FIG. 3 is a flowchart illustrating one embodiment of a process for signature authentication utilizing the “Low conjecture” for prime number identification.

FIG. 4 is a schematic illustration of one embodiment of a computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

The present relates to the use of the “Low conjecture” to find prime numbers for use in encryption. Specifically, probabilistic methods for finding primes have also been a failure when it comes to Mersenne Primes. The “Low Conjecture” provides a boundary condition on Mersenne Primes, thereby enabling prime numbers to be found faster.

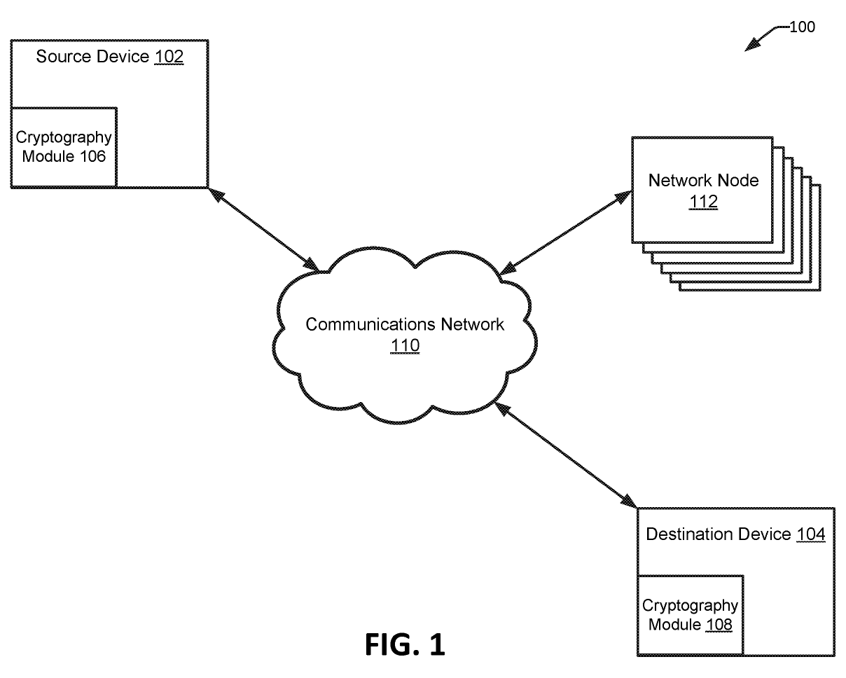

With reference now to FIG. 1, a schematic depiction of one embodiment of an encryption system 100 is shown. In some embodiments, the encryption system 100 can be configured to generate one or several keys for encrypting digital information. This digital information can be, in some embodiments, stored information or communicated information.

The system 100 includes a plurality of devices 102, 104. These devices 102, 104 can include a computing device that can include, for example, one or several processors, memory, or the like. In some embodiments, the memory can include instructions that can comprises computer code, that when executed by the processor cause the processor to take one or more actions and/or execute one or more algorithms.

These devices 102, 104 can include, in some embodiments, a source device 102 and a destination device 104, also referred to herein as a recipient device 104. In embodiments in which a communication is being sent, the source device 102 can be the originating device of the communication and the destination device 104 can be the recipient of the communication.

Each of the devices can include a cryptography module 106, 108. The cryptography module can be configured to generate one or several cryptography keys, also referred to herein as “keys”, to receive and/or store one or several keys, and/or to utilize one or several keys to encrypt and/or decrypt digital data include stored digital data and/or one or several digital communications.

Each of the cryptography modules 106, 108 can include for example, one or more Hardware Security Modules (HSMs), one or more printed wiring assemblies, one ore more microcircuits, or the like. In some embodiments, the HSM can be a hardened and/or tamper-resistant hardware device. The HSM can be configured to secure cryptographic processes by generating, protecting, and managing keys used for encrypting and/or decrypting data and/or creating digital signatures and certificates.

The HSM can be a physical hardware device located on each of the plurality of devices 102, 104, or can be located in the cloud and provided as a service. In some embodiments, the HSM can include, for example, one or more cryptographic chips configured to prevent bus probing and/or tampering, tamper-resistant packaging, access controls, an API, an encryption block, an authentication block, and/or a random number generator.

In some embodiments, the cryptography modules 106, 108 can include a first cryptography module 106 associated with the source device 102 and a second cryptography module 108 associated with the destination device 102. In some embodiments, the first cryptography module 106 can be located on the source device 102 and/or can be accessible by the source device 102, and/or in some embodiments, the second cryptography module 108 can be located on the destination device 104 and/or can be accessible by the destination device 104.

As indicated in FIG. 1, the source device 102 and the destination device 104 can be communicatively coupled. In some embodiments, and via this communicative coupling, the source device 102 and the destination device 104 can communicate with each other via, for example, the transmission of digital communications. In some embodiments, this communication can be according to any desired communication protocol including, for example, TCP/IP, POP, SMTP, HTTP, and/or the like.

In some embodiments, the source device 102 and the destination device 104 can be communicatively coupled via a communications network 110. The communications network 110 can be a public network such as the internet, a private network, or the like. In some embodiments, the communications network 110 can be a wired network, a wireless network, a combination wired and wireless network, or the like.

The system 100 can further include one or several network nodes 112. These network nodes 112 can include one or several processing devices communicatingly coupled to the communications network 110. In some embodiments, these one or several processing devices can include one or several servers, server farms, or the like. In some embodiments, the one or several network nodes 112 can each be configured to interact with and form part of a distributed ledger that is a blockchain. In some embodiments, each of the network nodes 112 can be configured to adhere to a consensus algorithm protocol to add and validate new transaction blocks in the blockchain.

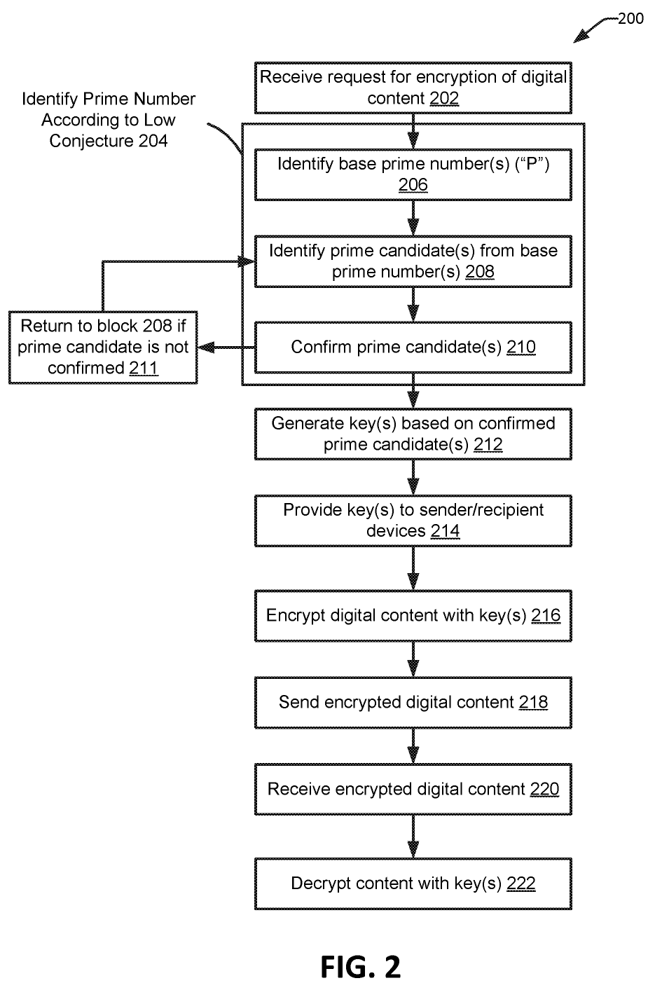

With reference now to FIG. 2, a flowchart illustrating one embodiment of a process 200 for cryptography utilizing the “Low conjecture” for prime number identification is shown. The process can be performed by all or portions of system 100. In some embodiments, all or portions of the system 100 can be performed by one or more of the cryptography modules 106, 108. In some embodiments, the process 200 can be embodied in a computer-program product tangibly embodied in a non-transitory machine-readable storage medium, which computer-program product can include instructions configured to cause one or more data processors to perform actions corresponding to the steps of process 200.

The Low conjecture can be used to identify prime numbers which can provide enhanced and improved encryption. This can include their use in the generation of one or more public and/or private keys which can be used to send and/or receive encrypted data, to encrypt information into a blockchain, to sign data and/or a transaction, or the like.

In some embodiments, prime numbers identified via the Low conjecture can be utilized in post-quantum cryptography such as, for example, lattice-based cryptography and/or hash-based cryptography.

Lattice-based cryptography can, in some embodiments, leverage the complex mathematical structures of lattices to create secure cryptographic systems. A lattice is a grid-like structure in multi-dimensional space, represented by a periodic arrangement of points that extends infinitely in all directions. The security of lattice-based cryptography stems from the computational difficulty of solving certain mathematical problems within these structures, such as the Shortest Vector Problem (SVP) and the Learning With Errors (LWE) problem. These problems can be hard to solve even with the power of quantum computers, making lattice-based cryptography a promising candidate for securing data in the post-quantum era.

Cryptographic schemes based on lattices are versatile and can be used to construct a variety of secure primitives, including encryption algorithms, digital signatures, and key exchange protocols. Additionally, lattice-based systems are efficient and scalable, offering advantages in terms of performance and resistance to side-channel attacks. They also enable advanced cryptographic functionalities, such as fully homomorphic encryption, which allows computations on encrypted data without the need for decryption.

Prime numbers can be utilized in the construction of secure lattice structures and related algorithms. While lattice-based cryptography primarily relies on complex geometric problems, such as the Shortest Vector Problem (SVP) and Learning With Errors (LWE), prime numbers are often used in modular arithmetic operations and ring-based lattice constructions. For example, cryptographic schemes like Ring-LWE utilize mathematical rings that are defined over polynomials with coefficients in modular arithmetic, where the modulus is frequently a prime number. The use of primes ensures desirable mathematical properties, such as the irreducibility of certain polynomials and the ability to efficiently perform modular operations, which are critical for the security and performance of these schemes. Additionally, prime numbers contribute to the generation of secure keys and parameters that underpin lattice-based algorithms, helping to maintain their resistance to both classical and quantum attacks. Prime numbers identified by the Low conjecture can improve lattice-based encryption by rapidly identifying very large prime numbers, the unique properties of which prime numbers, can be utilized by lattice-based cryptographic systems to achieve improved post-quantum cryptography.

Hash-based cryptography utilizes on the mathematical properties of cryptographic hash functions to create secure and efficient digital signatures and authentication mechanisms. Cryptographic hash functions are one-way mathematical algorithms that take an input (or message) and produce a fixed-size output, known as a hash or digest, which is unique to that input. Their one-way nature ensures that it is computationally infeasible to reverse the process or derive the original input from the hash, while their collision resistance makes it extremely unlikely for two different inputs to produce the same output.

Hash-based cryptographic systems, such as the Merkle Signature Scheme (MSS) and its variants like eXtended Merkle Signature Scheme (XMSS), utilize hash functions to generate digital signatures that are resistant to both classical and quantum computational attacks. These systems are particularly attractive as post-quantum cryptography solutions due to their simplicity, strong security guarantees, and reliance on well-understood cryptographic primitives. Unlike traditional public-key cryptography, which often depends on the hardness of problems like integer factorization or discrete logarithms, hash-based cryptography derives its security solely from the robustness of the underlying hash function.

Prime numbers, and particularly large numbers such as can be rapidly identified via the Low conjecture can enhance the design and implementation of certain hash-based cryptographic schemes. For example, prime numbers are often used in modular arithmetic operations within hash function constructions, where they help ensure uniform distribution of hash outputs and minimize collisions. Some hash-based systems, especially those involving keyed hash functions or pseudo-random number generators, incorporate prime numbers in key derivation processes to improve randomness and security. Additionally, prime numbers may be used to define mathematical structures, such as prime-order groups or fields, which can support certain advanced cryptographic features in hash-based protocols. Although the primary strength of hash-based cryptography lies in the one-way and collision-resistant properties of hash functions, the incorporation of prime numbers can enhance the robustness, performance, and cryptographic strength of these systems, particularly in complex implementations or post-quantum adaptations. Thus, the Low conjecture can improve hash-based encryption by rapidly identifying very large prime numbers, the unique properties of which prime numbers, can be utilized by hash-based cryptographic systems to achieve improved post-quantum cryptography.

The process 200 begins at block 202 wherein a request for encryption of digital content is received. This content can, in some embodiments, the content stored on the device, can be a digital communication including, for example, digital content to be communicated from a source device 102 to a destination device 104, or the like.

At block 204 a prime number is identified according to the “Low conjecture”. In some embodiments, the "Low conjecture” is embodied in the steps of block 204, and specifically in the steps of block 206, 208, 210. In some embodiments, the identifying of a prime number according to the “Low conjecture” can include, and as depicted in block 206, identifying one or several base prime numbers (“P”). In some embodiments, these one or several base prime numbers can be one or several numbers that are known to be prime numbers.

At block 208, and as part of identifying a prime number according to the “Low conjecture”, one or several prime candidates can be identified from the base prime numbers. In some embodiments, identifying the one or several prime candidates can include, for example, for each P, determining a sample value (“M”) where M = (P+1)²/2. After M has been determined, a lower number (“Φ”) can be identified. In some embodiments, Φ can be the smallest prime number in the set Φ_{P}, wherein Φ_{P} = M-kP, wherein k is a positive integer value. With Φ identified, an upper prime candidate (“λ”) can be identified. In some embodiments, λ = (P+1)²-Φ. In some embodiments, the upper prime candidate λ can be identified as the prime candidate.

At block 210, and as part of identifying a prime number according to the “Low conjecture”, the prime candidate is evaluated to determine whether the prime candidate is confirmed. In some embodiments, this can include confirming that the prime candidate λ is in fact a prime number.

If it is determined that the prime candidate is not in fact a prime number, then the process continues and returns to block 208 as indicated in block 211 and a new prime candidate is identified. In some embodiments, this can include identifying a new, and larger lower number Φ and using that larger lower number Φ to find a new, and smaller upper prime candidate λ.

Returning again to block 210, if it is determined that the prime candidate is in fact a prime number, then the process 200 proceeds to block 212, wherein a key is generated based on the confirmed prime candidate. In some embodiments, this can include, for example, multiplying two prime numbers with each other.

In some embodiments, generating the key can include selecting two prime numbers, for example, a first number “p” and a second number “q”. These primes must be chosen to ensure they are both unique and sufficiently large to provide strong security. Specifically, the larger the prime numbers, the more computationally difficult it becomes for attackers to factorize their product. One or both of these prime numbers can be generated according to the Low conjecture.

After these prime numbers have been selected, their product can be calculated to form the modulus “n”, wherein n = p*q. The modulus can be used in an encryption process such as, for example, and RSA (Rivest-Shamir-Adleman) encryption process and can be used in both the public and private keys. The size of modulus n determines the overall strength of the encryption; for instance, a 2048-bit RSA key requires that the modulus n be at least 2048 bits in length.

After the modulus has been calculated, the Euler’s totient function can be calculated as follows, φ(n) = (p-1) * (q-1). This number represents the number of integers less than the modulus n that are relatively prime to the modulus. The totient can be used in the key generation process to ensure that the encryption and decryption keys are mathematically compatible. In some embodiments, and instead of Euler’s totient, Carmicheal’s totient can be utilized. In such an embodiment, Carmicheal’s totient λ(n) = lcm(p − 1, q − 1).

The public key can then be generated. In some embodiments, the public key can consist of two components: the modulus n and a public exponent “e”. The exponent e can be chosen as a small, odd integer (commonly 3, 17, or 65537) that is relatively prime to the Euler’s totient φ(n). This ensures that the exponent e and Euler’s totient φ(n) share no common factors.

The private key can be derived using the modulus n, the public exponent e, and either Euler’s totient φ(n) in embodiments in which Euler’s totient φ(n) is calculated, or Carmicheal’s totient λ(n) in embodiments in which Carmicheal’s totient λ(n) is calculated. Specifically, the private key exponent “d” can be calculated as the modular multiplicative inverse of e modulo φ(n), written in equation form: d ≡ e ⁻¹ (mod φ(n)). In such an embodiment, the private key exponent d satisfies the equation d⋅e ≡ 1 (mod φ(n)).

At block 214 the cryptography key can be provided to one or more devices 102, 104. In some embodiments, this can include providing the cryptography key to the sender device 102 and/or to the recipient device 104. In some embodiments, the cryptography key, which can be generated by one or more of the cryptography modules 106, 108 can be provided to the sender device 102 and/or to the recipient device 104. In some embodiments, a private key can be provided to one or both of the sender device 102 and the recipient device 104. In some embodiments, for example, a sender private key can be provided to the sender device 102 and a recipient private key can be provided to the recipient device 104.

In some embodiments, P can be a Mersenne prime of the form (2ⁿ)-1. In some embodiments, the exponent n in P, can be when paired with k to thereby generate a prime pair to thereby form a key of the key. In some embodiments, this can be iteratively performed to create layers of keys.

In some embodiments, one member of each prime pair can be used as the key, and the other member of the prime pair can be used as the “lock”. In such an embodiment, only one of the members of the prime pair can be sent to the recipient device 104, either with P or with the exponent n of P to recreate the other member on the receiving side. Alternatively, one can send the exponent n of P and k as in above with the understanding that the lower number or greater prime is the key or the lock, respectively.

At block 216, the digital content is encrypted with the key. In some embodiments, the content can be encrypted with the key at the source device 102 and/or at the cryptography module 106 of the source device 102. In embodiments in which the digital content is not part of a message, then the encrypted digital content can be stored. In some embodiments, for example, the sender device 102 can encrypt the digital content with a public key such as, for example, a public key of the recipient device 104.

At block 218, the encrypted digital content is sent from the source device 102 to the recipient device 104. In some embodiments, the digital content can be sent via the communication network 110.

At block 220, the encrypted digital content is received by the recipient device 104. The content can be received by the recipient device 104 via the communication network 110.

At block 222, the digital content is decrypted with the key. In some embodiments, this can include the decryption of the digital content by the destination device 104 and/or by the cryptography module 108 of the destination device 104. In some embodiments, this can include the decryption of the digital content with a private key, and in some embodiments can include the decryption of the digital content by the recipient device 104 with the recipient device’s 104 private key.

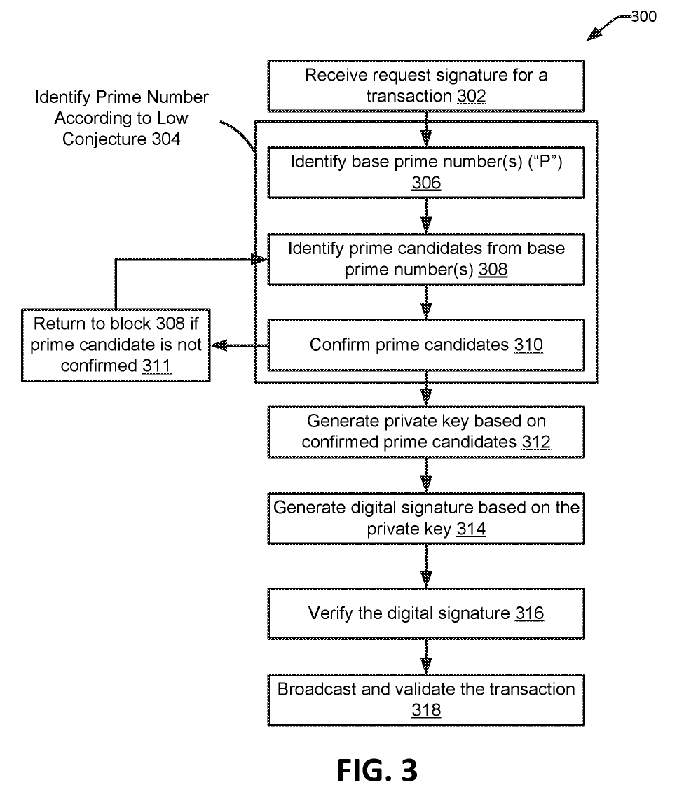

With reference now to FIG. 3, a flowchart illustrating one embodiment of a process 300 for signature authentication utilizing the “Low conjecture” for prime number identification is shown. The process 300 can be performed by all or portions of system 100. In some embodiments, all or portions of the system 100 can be performed by one or more of the cryptography modules 106, 108. In some embodiments, the process 300 can be embodied in a computer-program product tangibly embodied in a non-transitory machine-readable storage medium, which computer-program product can include instructions configured to cause one or more data processors to perform actions corresponding to the steps of process 300.

The process 300 begins at block 302, wherein a signature for a transaction is requested. In some embodiments, prime numbers identified via the Low conjecture can be used in a blockchain system, thereby enabling secure and verifiable digital signatures. These signatures can, in some embodiments, ensure the integrity and authenticity of transactions while preventing unauthorized tampering. At block 302, generation of a signature is requested in connection with a transaction, such as a transaction in blockchain. In some embodiments, the request can be received at the source device 102.

At block 304 a prime number is identified according to the “Low conjecture”. In some embodiments, the "Low conjecture” is embodied in the steps of block 304, and specifically in the steps of block 306, 308, 310. In some embodiments, the identifying of a prime number according to the “Low conjecture” can include, and as depicted in block 306, identifying one or several base prime numbers (“P”). In some embodiments, these one or several base prime numbers can be one or several numbers that are known to be prime numbers.

At block 308, and as part of identifying a prime number according to the “Low conjecture”, one or several prime candidates can be identified from the base prime numbers. In some embodiments, identifying the one or several prime candidates can include, for example, for each P, determining a sample value (“M”) where M = (P+1)²/2. After M has been determined, a lower number (“Φ”) can be identified. In some embodiments, Φ can be the smallest prime number in the set Φ_{P}, wherein Φ_{P} = M-kP, wherein k is a positive integer value. With Φ identified, an upper prime candidate (“λ”) can be identified. In some embodiments, λ = (P+1)²-Φ. In some embodiments, the upper prime candidate λ can be identified as the prime candidate.

At block 310, and as part of identifying a prime number according to the “Low conjecture”, the prime candidate is evaluated to determine whether the prime candidate is confirmed. In some embodiments, this can include confirming that the prime candidate λ is in fact a prime number.

If it is determined that the prime candidate is not in fact a prime number, then the process continues and returns to block 308 as indicated in block 311 and a new prime candidate is identified. In some embodiments, this can include identifying a new, and larger lower number Φ and using that larger lower number Φ to find a new, and smaller upper prime candidate λ.

Returning again to block 310, if it is determined that the prime candidate is in fact a prime number, then the process 300 proceeds to block 312, wherein a private key is generated based on the confirmed prime candidate(s). In some embodiments, this can include, for example, multiplying two prime numbers with each other.

In some embodiments, generating the key can include selecting two prime numbers, for example, a first number “p” and a second number “q”. These primes must be chosen to ensure they are both unique and sufficiently large to provide strong security. Specifically, the larger the prime numbers, the more computationally difficult it becomes for attackers to factorize their product. One or both of these prime numbers can be generated according to the Low conjecture.

After these prime numbers have been selected, their product can be calculated to form the modulus “n”, wherein n = p*q. The modulus can be used in an encryption process such as, for example, and RSA encryption process and can be used in both the public and private keys. The size of modulus n determines the overall strength of the encryption; for instance, a 2048-bit RSA key requires that the modulus n be at least 2048 bits in length.

After the modulus has been calculated, the Euler’s totient function can be calculated as follows, φ(n) = (p-1) * (q-1). This number represents the number of integers less than the modulus n that are relatively prime to the modulus. The totient can be used in the key generation process to ensure that the encryption and decryption keys are mathematically compatible. In some embodiments, and instead of Euler’s totient, Carmicheal’s totient can be utilized. In such an embodiment, Carmicheal’s totient λ(n) = lcm(p − 1, q − 1).

A public exponent “e” can be selected. The exponent e can be chosen as a small, odd integer (commonly 3, 17, or 65537) that is relatively prime to the Euler’s totient φ(n). This ensures that the public exponent e and Euler’s totient φ(n) share no common factors.

The private key can be derived using the modulus n, the public exponent e, and either Euler’s totient φ(n) in embodiments in which Euler’s totient φ(n) is calculated, or Carmicheal’s totient λ(n) in embodiments in which Carmicheal’s totient λ(n) is calculated. Specifically, the private key exponent “d” can be calculated as the modular multiplicative inverse of e modulo φ(n), written in equation form: d ≡ e ⁻¹ (mod φ(n)). In such an embodiment, the private key exponent d satisfies the equation d⋅e ≡ 1 (mod φ(n)).

In some embodiments, and in addition to a private key, a public key can be generated. In some embodiments, the public key can consist of two components: the modulus n and a public exponent “pub-e”. The exponent e can be chosen as a small, odd integer (commonly 3, 17, or 65537) that is relatively prime to the Euler’s totient φ(n). This ensures that the exponent e and Euler’s totient φ(n) share no common factors.

At block 314, a digital signature is generated based on the private key. To generate a digital signature for a blockchain transaction, the message (or transaction data) is first hashed using a cryptographic hash function, such as SHA-256. The hash output is then raised to the power of the private key d and reduced modulo n to produce the signature s. Written as an equation, s = ([hash(message)]^{d} ) / (mod n). In some embodiments, the signature s is unique to the message and can only be generated by the private key holder. The signature can be attached to the transaction and broadcast to the blockchain network for validation.

At block 316, the digital signature is verified. In some embodiments, the signature can be verified by the same device that created the signature and/or the public key and/or private key associated with the signature, and in some embodiments, a device other than the device that created the signature and/or other than the device that created the private key and/or the public key associated with the signature. In some embodiments, for example, the signature can be verified by the source device 102, by the destination device 104, and/or by one or several network nodes 112. In some embodiments, the signature can be verified by the recipient and/or by one or more network nodes utilizing the senders public key, which can include “pub-e” and “n”. In some embodiments, verifying the digital signature can include raising the signature to the power of pub-e and reduced modulo n. The result can then be compared to the hash of the original message. If the result of the decryption of the signature matches the hash of the original message, then it is confirmed that the signature was generated using the corresponding private key, thereby ensuring the authenticity and integrity of the transaction. Written as an equation, the verification includes determining if: hash(message) = (s^{pub-e} ) / mod n.

At block 318, and once the digital signature is verified, the transaction is considered valid and is added to the blockchain. The use of prime numbers in key generation ensures that the private key remains secure, even in the presence of public key distribution. This enables trustless verification across decentralized blockchain networks without revealing sensitive information.

In some embodiments, and to maintain security over time, blockchain systems may periodically update cryptographic keys by regenerating new primes p and q. This can ensure continued resistance to evolving computational threats, including advancements in quantum computing.

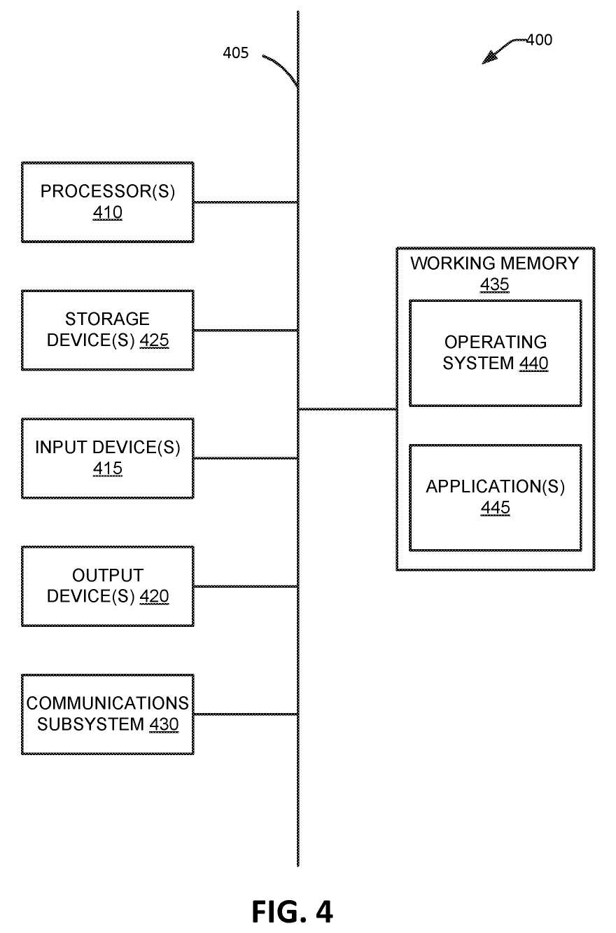

With reference now to FIG. 4, a computer system may be incorporated as part of the previously described computerized devices. For example, computer system 400 can represent some of the components of system 100, processor 106, and/or other computing devices described herein. FIG. 4 provides a schematic illustration of one embodiment of a computer system 400 that can perform the methods provided by various other embodiments, as described herein. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include a processing unit 410, including without limitation one or more processors, such as one or more special-purpose processors (such as digital signal processing chips, graphics acceleration processors, and/or the like); one or more input devices 415, which can include without limitation a keyboard, a touchscreen, receiver, a motion sensor, an imaging device, and/or the like; and one or more output devices 420, which can include without limitation a display device, a speaker, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communication interface 430, which can include without limitation a modem, a network card (wireless or wired), an infrared communication device, a wireless communication device and/or chipset (such as a Bluetooth™ device, a 502.11 device, a Wi-Fi device, a WiMAX device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 410, applications 445, etc.) Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage devices(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire, and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a non-transitory storage device 425 either before or after execution by the processing unit 410.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

The methods, systems, devices, graphs, and tables discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles "a" and "an" refer to one or to more than one (i.e., to at least one) of the grammatical object of the article. By way of example, "an element" means one element or more than one element. "About" and/or "approximately" as used herein when referring to a measurable value such as an amount, a temporal duration, and the like, encompasses variations of ±20% or ±10%, ±5%, or +0.1 % from the specified value, as such variations are appropriate to in the context of the systems, devices, circuits, methods, and other implementations described herein. "Substantially" as used herein when referring to a measurable value such as an amount, a temporal duration, a physical attribute (such as frequency), and the like, also encompasses variations of ±20% or ±10%, ±5%, or +0.1 % from the specified value, as such variations are appropriate to in the context of the systems, devices, circuits, methods, and other implementations described herein. As used herein, including in the claims, "and" as used in a list of items prefaced by "at least one of' or "one or more of' indicates that any combination of the listed items may be used. For example, a list of "at least one of A, B, and C" includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of "at least one of A, B, and C" may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words "comprise", "comprising", "contains", "containing", "include", "including", and "includes", when used in this specification and in the following claims, are intended to specify the presence of stated features, integers, components, or steps, but they do not preclude the presence or addition of one or more other features, integers, components, steps, acts, or groups.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term "storage medium" may represent one or more memories for storing data, including read only memory (ROM), random access memory (RAM), magnetic RAM, core memory, magnetic disk storage mediums, optical storage mediums, flash memory devices and/or other machine readable mediums for storing information. The term "machine-readable medium" includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A cryptography method comprising:
receiving a request for encryption of a digital message at a source device;
identifying at least one prime number by:
identifying a base prime number (“P”);
identifying at least one prime candidate from the base prime number; and
confirming the at least the prime candidate as a prime number;
generating an encryption key based on the at least one prime number;
distributing the key to at least a destination device;
encrypting the digital message with the encryption key; and
sending the encrypted digital message from the source device to the destination device.

2. The method of claim 1, wherein identifying the at least one prime candidate comprises:
determining a sample value (“N”) where N = (P+1)²/2;
identifying a lower number (“Φ”), wherein Φ is the smallest prime number in a set Φ_{P} wherein Φ_{P} = N-k•P, wherein k is a positive integer value; and
identifying an upper prime candidate (“λ”), wherein λ = (P+1)²⁻²-Φ.

3. The method of claim 2, wherein the at least one prime candidate comprises the upper prime candidate.

4. The method of claim 1, wherein the request for encryption of the digital message is received at a source device that comprises a cryptography module configured to encrypt the digital message and that comprises a Hardware Security Module (HSM).

5. The method of claim 1, wherein the encryption key is generated according to a Rivest-Shamir-Adleman (“RSA”) algorithm.

6. The method of claim 1, wherein generating the encryption key comprises:
selecting a first prime number “p” and a second prime number “q”; and
forming a modulus “n” by multiplying “p” and “q”.

7. The method of claim 6, wherein generating the encryption key further comprises calculating Euler’s totient function (“φ(n)”) based on “p” and “q”.

8. The method of claim 7, wherein calculating the Euler’s totient function (“φ(n)”) comprises multiplying (p-1) with (q-1).

9. The method of claim 1, wherein generating the encryption key comprises generating a public key and a private key.

10. The method of claim 9, wherein the public key comprises a public exponent “e” and modulus “n”, and wherein the private key is derived based on the modulus “n”, the public exponent “e”, and Euler’s totient function “φ(n)”).

11. A system comprising a source device comprising:
one or more processors; and
memory comprising instructions that when executed cause the one or more processors to:
receive a request for encryption of a digital message at a source device;
identify at least one prime number by:
identifying a base prime number (“P”);
identifying at least one prime candidate from the base prime number; and
confirming the at least the prime candidate as a prime number;
generate an encryption key based on the at least one prime number;
distribute the key to at least a destination device;
encrypt the digital message with the encryption key; and
send the encrypted digital message from the source device to the destination device.

12. A computer-program product tangibly embodied in a non-transitory machine-readable storage medium, including instructions configured to cause one or more data processors to perform a set of actions including:
receiving a request for encryption of a digital message at a source device;
identifying at least one prime number by:
identifying a base prime number (“P”);
identifying at least one prime candidate from the base prime number; and
confirming the at least the prime candidate as a prime number;
generating an encryption key based on the at least one prime number;
distributing the key to at least a destination device;
encrypting the digital message with the encryption key; and
sending the encrypted digital message from the source device to the destination device.

13. The computer-program product of claim 12, wherein identifying the at least one prime candidate comprises:
determining a sample value (“N”) where N = (P+1)²/2;
identifying a lower number (“Φ”), wherein Φ is the smallest prime number in a set Φ_{P} wherein Φ_{P} = N-k•P, wherein k is a positive integer value; and
identifying an upper prime candidate (“λ”), wherein λ = (P+1)²⁻¹³-Φ.

14. The computer-program product of claim 13, wherein the at least one prime candidate comprises the upper prime candidate.

15. The computer-program product of claim 12, wherein the request for encryption of the digital message is received at a source device that comprises a cryptography module configured to encrypt the digital message and that comprises a Hardware Security Module (HSM).

16. The computer-program product of claim 12, wherein the encryption key is generated according to a Rivest-Shamir-Adleman (“RSA”) algorithm.

17. The computer-program product of claim 12, wherein generating the encryption key comprises:
selecting a first prime number “p” and a second prime number “q”; and
forming a modulus “n” by multiplying “p” and “q”.

18. The computer-program product of claim 17, wherein generating the encryption key further comprises calculating Euler’s totient function (“φ(n)”) based on “p” and “q”.

19. The computer-program product of claim 18, wherein calculating the Euler’s totient function (“φ(n)”) comprises multiplying (p-1) with (q-1).

20. The computer-program product of claim 19, wherein generating the encryption key comprises generating a public key and a private key.
